(19) United States
(12) Patent Application Publication
(10) Pub. No.: US 2025/0063089 A1
(43) Pub. Date: Feb. 20, 2025

(54) Apparatus and Method for Actuating a Function of a Motor Vehicle and Motor Vehicle

(71) Applicant: Bayerische Motoren Werke Aktiengesellschaft, Muenchen (DE)

(72) Inventors: Christian BUCHNER, Poing (DE); Kai HOESL, Iffeldorf (DE)

(21) Appl. No.: 18/799,027

(22) Filed: Aug. 9, 2024

(30) Foreign Application Priority Data
Aug. 17, 2023 (DE) 10 2023 122 096.9

(51) Int. Cl. H04L 67/12; B60W 10/04; G07C 9/00; H04W 4/40

(52) U.S. Cl. CPC H04L 67/12; B60W 10/04; G07C 9/00309; H04W 4/40

(57) ABSTRACT

An apparatus and a method for actuating a function of a motor vehicle are provided. The apparatus has a first transmission/reception device arranged at a first location of the motor vehicle and designed to receive a functional signal for actuating a function of the motor vehicle from a functional device different from the motor vehicle and to transmit a first acknowledgement signal, a second transmission/reception device arranged at a second location of the motor vehicle and designed to receive the acknowledgement signal from the first transmission/reception device, a control device in communication with the first transmission/reception device and the second transmission/reception device and designed to measure a propagation time of the first acknowledgement signal from the first transmission/reception device to the second transmission/reception device, to compare same with a predetermined threshold value, and to actuate or disable the function based on the comparison.

### CROSS REFERENCE TO RELATED APPLICATION

This application claims priority under 35 U.S.C. § 119 from German Patent Application No. 10 2023 122 096.9, filed Aug. 17, 2023, the entire disclosure of which is herein expressly incorporated by reference.

### BACKGROUND AND SUMMARY

The invention relates to an apparatus and a method for actuating a function of a motor vehicle and to a motor vehicle having an apparatus of this type.

Currently, it is possible to access functions of motor vehicles from outside via one or more transmission/reception devices that communicate with a functional device. However, these transmission/reception devices can be manipulated.

It is thus necessary to be protected against an improper artificial extension of the radio range (so-called relay attacks), such that a request signal of the motor vehicle is prevented from being transmitted beyond the original radio range of the motor vehicle to the functional device outside of the vehicle in order to cause the functional device to transmit its response signal without the user's knowledge.

Possible protection against an artificial range extension is known, for example, from DE 199 27 253 A1. Accordingly, an authentication unit is equipped with an additional motion sensor and, upon receiving the request signal from a motor vehicle, it is checked whether the authentication unit has been in motion during a predetermined time interval prior thereto. This solution assumes that a user performs stepping movements when approaching a motor vehicle, which can be detected by the motion sensor and used to verify the plausibility of the activation process. If, on the other hand, the authentication unit is unused, for example in a residential building, it is inoperative and, even in the event that a request signal from a motor vehicle is forwarded to the authentication unit, then a response signal is prevented from being generated by the authentication unit, and so an activation process fails.

The object of the invention is to provide an improved apparatus and an improved method for actuating a function of a motor vehicle.

This object is achieved according to the invention by the subject of the independent patent claims. Advantageous embodiments of the invention are the subject of the dependent patent claims and the description.

An apparatus according to the invention for actuating a function of a motor vehicle comprises a first transmission/reception device (transceiver) which is arranged at a first location of the motor vehicle and designed to receive a functional signal for actuating a function of the motor vehicle from a functional device different from the motor vehicle and to transmit a first acknowledgement signal, a second transmission/reception device which is arranged at a second location of the motor vehicle and designed to receive the acknowledgement signal from the first transmission/reception device, and a control device which is in communication with the first transmission/reception device and the second transmission/reception device and designed to measure a propagation time of the first acknowledgement signal from the first transmission/reception device to the second transmission/reception device, to compare same with a predetermined threshold value, and to actuate or disable the function based on the comparison.

The apparatus is used, in particular, to identify a manipulation of a transmission/reception device and thus prevent unauthorized access to functions of the motor vehicle.

For this purpose, the apparatus initially comprises a first transmission/reception device which is arranged at a first location of the motor vehicle.

A transmission/reception device may also be referred to as a transceiver, antenna or anchor and is a device of the motor vehicle used to transmit and receive signals. In particular, the transmission/reception device is designed to receive signals wirelessly.

The first transmission/reception device is arranged in this case at a first location of the motor vehicle, in particular at or near a body part, such as in or on a fender, in or on a skirt, in or on a roof element, such as a roof liner, and/or in or on an A, B and/or C pillar.

The transmission/reception device is designed in this case to receive a functional signal for actuating a function of the motor vehicle from a functional device different from the motor vehicle.

A functional device is in this case an independent object, different from the motor vehicle and spatially separable therefrom, and is used to trigger, perform or effect functions by way of a user of the motor vehicle, without the functional device itself having to be present in the motor vehicle. To this end, the functional device may be arranged at a distance from the motor vehicle for operation, for example 1 m, 2 m, 5 m or 10 m.

To this end, the functional device is designed to communicate, in particular wirelessly, with the motor vehicle or the transmission/reception devices. In particular, the functional device uses ultra-wideband technology (UWB) for this purpose. In particular, the functional signal comprises a characteristic pulse signal from which the desired function can be derived. In addition, the functional device can also support or use another radio technology using which the communication via UWB is prepared and/or initiated.

The functional device may be designed, in particular, as a proprietary piece of equipment, such as a key, transponder and/or fob, and provide one or more functions of the motor vehicle via dedicated keys or pushbuttons.

As an alternative or in addition, the functional device may also be designed as a mobile radio device, in particular as a smartphone, phablet, tablet and/or wearable, which also provides functions of the motor vehicle by means of one or more applications.

The first transmission/reception device is also designed to transmit a first acknowledgement signal. In this case, the first transmission/reception device may be designed, in particular, to transmit the first acknowledgement signal in response to the reception of the functional signal. As an alternative or in addition, the first transmission/reception device can be designed to transmit the first acknowledgement signal cyclically, periodically and/or without cause.

The acknowledgement signal can in this case also be transmitted wirelessly, in particular also by means of UWB technology.

The apparatus also comprises a second transmission/reception device which is arranged at a second location of the motor vehicle and likewise designed to receive the functional signal from the functional device.

The second transmission/reception device is formed in this case similarly or identically to the previously described first transmission/reception device. In particular, the second transmission/reception device may also be designed to receive the functional signal. Only the first and second locations are different from one another.

For example, the first transmission/reception device is arranged on a front left fender and the second transmission/reception device is located at a central position in the roof liner, behind an interior mirror. In particular, the first transmission/reception device is at a distance of at least 30 cm, 50 cm, 100 cm or 150 cm from the second transmission/reception device.

The second transmission/reception device is designed to receive the acknowledgement signal transmitted by the first transmission/reception device.

In particular, provision is made of more than two such transmission/reception devices which are similar or identical in design, for example at least four, six, eight or ten such transmission/reception devices, each at different locations of the motor vehicle and/or spaced apart from one another.

The apparatus also comprises a control device which is in communication with the first transmission/reception device and the second transmission/reception device.

The control device is used to control, trigger and/or effect one or more functions of the motor vehicle, in particular also—but not exclusively—those that can be actuated by the functional device. The control device may in this case also be referred to as a control unit, in particular also as a central control unit, which may be processor, hardware and/or software based.

The control device is, in particular, connected to all transmission/reception devices, in particular in a wired manner, for example via a bus, such as a CAN bus, and is designed to communicate with these devices and, in particular, to obtain information therefrom.

The control device is in this case designed to measure a propagation time of the first acknowledgement signal from the first transmission/reception device to the second transmission/reception device.

A propagation time is the time required by the acknowledgement signal to travel from the first to the second transmission/reception device. The propagation time is usually in the millisecond, microsecond or nanosecond range.

The control device is also designed to compare the propagation time of the first acknowledgement signal with a predetermined threshold value and to actuate or disable the function based on the comparison.

In particular, the control device is designed not to trigger the function in the event of a deviation by a predetermined threshold value, which may be relative or absolute.

Conversely, the control device may be designed not to trigger or effect the requested function in the event of a deviation below a predetermined threshold value.

To this end, the control device may receive, in particular, information regarding the desired function from the first transmission/reception device and/or from the second transmission/reception device.

In particular, the first transmission/reception device may be disabled, both temporarily and permanently, in response to the fact that the propagation time of the acknowledgement signal exceeds the predetermined threshold value, and no functional signals received from this transmission/reception device are processed.

The apparatus according to the invention makes it possible to identify manipulation, in particular a movement of the first transmission/reception device away from the motor vehicle, and to carry out suitable defensive measures. In particular, providing the acknowledgement signal between the two transmission/reception devices creates a self-test option, which takes the propagation time into account between themselves.

This makes it possible to prevent unauthorized access to vehicle functions.

According to one development, the function comprises unlocking of the motor vehicle.

Unlocking may include one or more of the doors and all the doors of the motor vehicle. In addition or as an alternative, unlocking may include the trunk, in particular in connection with an automatic opening device that opens the trunk lid.

The unlocking may in this case be effected, in particular, by pressing a pushbutton on a key, transponder and/or fob and/or a button on a mobile radio device.

In particular, the unlocking may also take place contactlessly, that is to say without actual actuation of a pushbutton by a user, but purely by approaching the functional device. This type of function may also be referred to as keyless entry or convenient entry.

This development makes it possible to prevent unauthorized access to the interior particularly well.

According to one development, the function comprises ignition of the motor vehicle.

Ignition includes, in particular, the starting of an engine, in particular an internal combustion engine and/or an electric motor, and may also be referred to as providing, activating or initiating an engine function, according to which the motor vehicle can be moved or driven directly, for example by actuation of a gas pedal.

The ignition may in this case be carried out, for example, by actuating a pushbutton or button on the functional device and enable a so-called remote start, for example, to air-condition the vehicle, in particular to heat or cool the vehicle.

The ignition may also be achieved by actuation of a pushbutton or button in the motor vehicle which is not effected by an interaction with the functional device. In this case, however, the propagation time between the functional device and the first transmission/reception device and the propagation time between the functional device and the second transmission/reception device is measured and these are compared with one another in order to initiate this when a threshold value is undershot and to prevent this when the threshold value is exceeded.

This development makes it possible to prevent an unauthorized engine start particularly well.

A separate comparison can be made for both unlocking and ignition, and a two-stage test can be used as a basis therefor.

In particular, different threshold values, in particular higher threshold values or tolerances, can be set for the comparison for unlocking than for ignition. For example, a threshold value of 10%, 20%, 50% or 100% greater than a threshold value for ignition can be used as basis for the comparison for unlocking.

According to one development, the second transmission/reception device is designed to transmit a second acknowledgement signal in response to the reception of the first acknowledgement signal, wherein the first transmission/reception device is designed to receive the second acknowledgement signal, and wherein the control device is designed to measure a signal from the second propagation time of the second acknowledgement transmission/reception device to the first transmission/reception device, to compare same with a predetermined threshold value and to actuate or disable the function based on the comparison.

Therefore, according to this development, use is made of a second acknowledgement signal which is transmitted by the second transmission/reception device and received by the first transmission/reception device. The propagation time of this signal is also taken into account here by the control device and, if this is above the threshold value, the function is not executed or is disabled.

In particular, this development allows mutual confirmation of the first and second transmission/reception devices.

A method according to the invention for actuating a function of a motor vehicle comprises the steps of receiving a functional signal for actuating a function of the motor vehicle at a first transmission/reception device which is arranged at a first location of the motor vehicle from a functional device different from the motor vehicle, transmitting a first acknowledgement signal by way of the first transmission/reception device, receiving the first acknowledgement signal from the first transmission/reception device at a second transmission/reception device which is arranged at a second location of the motor vehicle, and measuring a propagation time of the first acknowledgement signal from the first transmission/reception device to the second transmission/reception device, comparing the propagation time with a predetermined threshold value, and actuating or disabling the function based on the comparison, by way of a control device which is in communication with the first transmission/reception device and the second transmission/reception device.

The method can be carried out, in particular, by an embodiment of the apparatus described above.

A motor vehicle according to the invention comprises an apparatus according to one of the embodiments described above.

With regard to the embodiments of the method and of the motor vehicle as well as the advantages thereof, reference is made to the previously described embodiments of the apparatus and the advantages thereof.

Further features of the invention emerge from the claims, the FIGURE and the description of the FIGURE. The features and feature combinations mentioned above in the description, and the features and feature combinations mentioned below in the description of the FIGURE and/or shown in the FIGURE alone, may be used not only in the respectively specified combination but also in other combinations or individually.

The invention will now be discussed in more detail on the basis of a preferred exemplary embodiment and with reference to the drawing.

### BRIEF DESCRIPTION OF THE DRAWING

FIG. 1 shows a schematic plan view of an embodiment of an apparatus and a method for actuating a function of a motor vehicle.

### DETAILED DESCRIPTION OF THE DRAWING

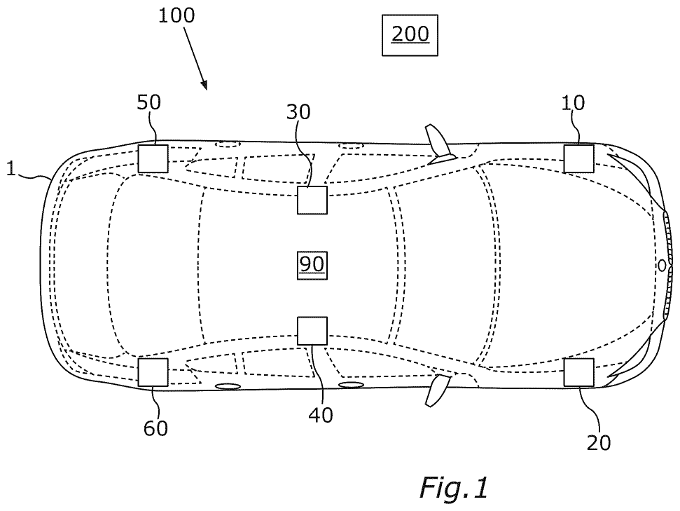

FIG. 1 shows a schematic plan view of an apparatus 100 and a method for actuating a function of a motor vehicle 1.

The apparatus 100 is in this case comprised by the motor vehicle 1 and is designed to perform or effect the method described in the following text.

The apparatus 100 in this case initially comprises a total of six transmission/reception devices 10, 20, 30, 40, 50 and 60 shown by way of example. In this case, a first transmission/reception device 10 is arranged on the left front fender, a second transmission/reception device 20 is arranged on the right front fender, a third transmission/reception device 30 is arranged at a left central position in the roof liner, a fourth transmission/reception device 40 is arranged at a right central position in the roof liner, a fifth transmission/reception device 50 is arranged on the left rear fender and a sixth transmission/reception device 60 is arranged on the right rear fender.

The transmission/reception devices 10, 20, 30, 40, 50, 60 are designed in this case to receive a functional signal for actuating a function of the motor vehicle 1 from a functional device 200 different from the motor vehicle 1 and located at a distance therefrom.

The transmission/reception devices 10, 20, 30, 40, 50, 60 are also designed to transmit an acknowledgement signal in response to the reception of the functional signal, which is received by the respective other transmission/reception devices 10, 20, 30, 40, 50, 60.

The apparatus 100 also comprises a control device 90 which is in communication with the transmission/reception devices 10, 20, 30, 40, 50, 60 and designed to measure a propagation time of the acknowledgement signal between the respective transmission/reception devices 10, 20, 30, 40, 50, 60, to compare same with a predetermined threshold value, and to actuate or disable the function based on the comparison.

In order to ensure that none of the UWB anchors (transmission/reception device) have been removed from the vehicle, the anchors measure the signal propagation time (distance) from one another. If an anchor is out of range of the other anchors or at a distance therefrom that is greater than a threshold value, that anchor is disabled for authentication.

If, for example, an authentication unit enters the area around the vehicle, for example the following self-measurement process is triggered:

Anchor 1 transmits a UWB pulse.

Anchors 2 and 5 receive the UWB pulse.

Anchor 2 responds to the UWB pulse.

Anchor 5 responds to the UWB pulse.

Anchor 1 responds to a UWB pulse.

Anchors 1, 2 and 5 report the measured propagation times/distances to the central control unit.

Anchors 1, 2 and 5 sign the measurement in order to exclude manipulation.

The function in this case comprises both unlocking of the motor vehicle 1 and ignition of the motor vehicle 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Motor vehicle
10 First transmission/reception device
20 Second transmission/reception device
30 Third transmission/reception device
40 Fourth transmission/reception device
50 Fifth transmission/reception device
60 Sixth transmission/reception device
90 Control device (unit)
100 Apparatus
200 Functional device

What is claimed is:

1. An apparatus for actuating a function of a motor vehicle, comprising:
a first transmission/reception device arranged at a first location of the motor vehicle and configured to receive a functional signal for actuating a function of the motor vehicle from a functional device different from the motor vehicle and to transmit a first acknowledgement signal;
a second transmission/reception device arranged at a second location of the motor vehicle and configured to receive the acknowledgement signal from the first transmission/reception device; and
a control device in communication with the first transmission/reception device and the second transmission/reception device, the control device being operatively configured to:
measure a propagation time of the first acknowledgement signal from the first transmission/reception device to the second transmission/reception device,
compare the measured propagation time with a predetermined threshold value, and
actuate or disable the function based on the comparison.

2. The apparatus according to claim 1, wherein the function comprises unlocking of the motor vehicle.

3. The apparatus according to claim 1, wherein the function comprises ignition of the motor vehicle.

4. The apparatus according to claim 1, wherein
the second transmission/reception device is configured to transmit a second acknowledgement signal in response to the reception of the first acknowledgement signal,
the first transmission/reception device is configured to receive the second acknowledgement signal, and
the control device is operatively configured to:
measure a second propagation time of the second acknowledgement signal from the second transmission/reception device to the first transmission/reception device,
compare the second propagation time with a second predetermined threshold value, and
actuate or disable the function based on the comparison.

5. A method for actuating a function of a motor vehicle, comprising:
receiving a functional signal for actuating a function of the motor vehicle at a first transmission/reception device arranged at a first location of the motor vehicle from a functional device different from the motor vehicle;
transmitting a first acknowledgement signal by way of the first transmission/reception device;
receiving the first acknowledgement signal from the first transmission/reception device at a second transmission/reception device arranged at a second location of the motor vehicle; and
measuring, by way of a control device which is in communication with the first transmission/reception device and the second transmission/reception device, a propagation time of the first acknowledgement signal from the first transmission/reception device to the second transmission/reception device, comparing the propagation time with a predetermined threshold value, and actuating or disabling the function based on the comparison.

6. The method according to claim 5, wherein the function comprises unlocking of the motor vehicle.

7. The method according to claim 5, wherein the function comprises ignition of the motor vehicle.

8. The method according to claim 5, further comprising:
transmitting a second acknowledgement signal in response to the reception of the first acknowledgement signal by way of the second transmission/reception device;
receiving the second acknowledgement signal at the first transmission/reception device; and
measuring, by way of the control device, a second propagation time of the second acknowledgement signal from the second transmission/reception device to the first transmission/reception device, comparing the second propagation time with a second predetermined threshold value, and actuating or disabling the function based on the comparison.

9. A motor vehicle comprising an apparatus according to claim 1.
